(19) United States
(12) Patent Application Publication
(10) Pub. No.: US 2026/0146978 A1
(43) Pub. Date: May 28, 2026

(54) TANDEM EVOLVED GAS - GAS CHROMATOGRAPHY - MASS SPECTROMETRY

(71) Applicant: UT-Battelle, LLC, Oak Ridge, TN (US)

(72) Inventor: Derek Dwyer, Oak Ridge, TN (US)

(21) Appl. No.: 19/392,930

(22) Filed: Nov. 18, 2025

Related U.S. Application Data
(60) Provisional application No. 63/725,395, filed on Nov. 26, 2024.

(51) Int. Cl. G01N 30/72; B01D 8/00; B01D 53/02; G01N 30/30; H01J 49/02

(52) U.S. Cl. CPC G01N 30/7206; B01D 8/00; B01D 53/025; G01N 30/30; H01J 49/025; G01N 2030/3023; G01N 2030/3084

(57) ABSTRACT

The present invention provides a system and a method for performing evolved gas analysis and gas chromatography on a single sample within a single experiment. The system and the method enable the simultaneous acquisition of thermal and compositional data by splitting evolved gases from a micro-furnace into two analytical pathways. A first pathway is directed to an evolved gas analysis (EGA) tube, and a second pathway is directed to a gas chromatography (GC) column following temporary cryogenic trapping. After completion of the EGA stage, the trapped gases are released and transferred into the GC column via an internal cryo-trap, and a GC-MS analysis is performed on the same sample. Upstream and downstream splitter connections and multiple transfer lines route gases efficiently without requiring additional sample preparation.

### CROSS-REFERENCE TO RELATED APPLICATIONS

This application claims the benefit of U.S. Provisional Application 63/725,395, filed Nov. 26, 2024, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### BACKGROUND OF THE INVENTION

The analysis of thermally evolved gases from polymeric materials can provide valuable information about a polymeric material's composition, thermal stability, degradation mechanisms, and kinetics. Conventional techniques such as thermogravimetric analysis coupled with gas chromatography-mass spectrometry (TGA/GC-MS) or evolved gas analysis-mass spectrometry (EGA-MS) require separate experiments to obtain thermal and compositional data. These methods consume large sample quantities, extend analysis times, and often yield incomplete or inconsistent correlations between thermal decomposition events and compositional data.

In TGA/GC-MS systems, sample mass and nonuniform heating can lead to thermal gradients, which obscure kinetic information and limit the detection of higher molecular weight species. Additionally, long transfer lines between the furnace and the GC column cause condensation losses and reduce analytical sensitivity. As a result, real-time correlation between a material's thermal profile (from EGA-MS) and its chromatographic product distribution (from GC-MS) has not been achievable with existing instrumentation.

Accordingly, there remains a continued need for an improved system capable of performing both EGA-MS and GC-MS analyses on the same sample in a single, continuous experiment. In particular, there remains a continued need for an improved system that reduces instrument downtime, eliminates sample-to-sample variability, and enables an accurate correlation between thermal events and specific degradation products.

### SUMMARY OF THE INVENTION

The present invention provides a system and a method for performing evolved gas analysis and gas chromatography on a single sample. The system and the method enable the acquisition of thermal and compositional data by splitting evolved gases from a micro-furnace into two analytical pathways. A first pathway is directed to an evolved gas analysis (EGA) tube, and a second pathway is directed to a gas chromatography (GC) column following temporary cryogenic trapping in an external cryo-trap. After completion of the EGA stage, the external cryo-trap is removed and the trapped gases are released and transferred into the GC column where they are concentrated at the head of the GC column via an internal cryo-trap, and a GC-MS analysis is performed on the same sample. Upstream and downstream splitter connections and multiple inert transfer lines route gases efficiently without requiring additional sample preparation.

These and other embodiments achieve a direct correlation between EGA thermograms and GC-MS chromatograms of the same material, while minimizing sample size and analytical time. By integrating evolved gas analysis and gas chromatographic separation within a single continuous analytical sequence, the present invention eliminates the need for multiple sample runs, extensive hardware reconfiguration, and duplicate data acquisition procedures. The present invention performs both analyses on the same sample, thereby ensuring a direct and quantifiable correlation between the thermal evolution profile and the chemical identities of its decomposition products. This correlation is particularly valuable for limited quantity materials, such as forensic samples, specialty polymers, and conservation artifacts. Dual cold traps, including both external and internal cryo-traps, enables efficient capture, storage, and timed release of evolved gases while preventing condensation losses. Lastly, dual splitter assemblies provide stable and reproducible division and recombination of gas streams, allowing EGA monitoring and deferred GC separation without manual intervention.

These and other features and advantages of the present invention will become apparent from the following description of the invention, when viewed in accordance with the accompanying drawings and appended claims.

### BRIEF DESCRIPTION OF THE FIGURES

FIG. 1 illustrates a system for performing evolved gas analysis mass spectrometry (EGA-MS) and gas chromatography mass spectrometry (GC-MS) on a single sample.

FIG. 2 illustrates a further embodiment in which the system includes one or more further external cold traps in accordance with the present invention.

### DETAILED DESCRIPTION OF THE CURRENT EMBODIMENTS

The invention as disclosed herein includes a system and a method for performing evolved gas analysis mass spectrometry (EGA-MS) and gas chromatography mass spectrometry (GC-MS) on the same sample. In general terms, the system is operable in an EGA-MS mode for measuring the temperature profile of the evolved gases via mass spectral monitoring and is operable in a GC-MS mode for chromatographically separated products for enhanced identification (chemical identity and composition) of the evolved gases. The system is discussed in Part I below, and its method of operation is discussed in Part II below.

### I. Tandem System for EGA-MS and GC-MS

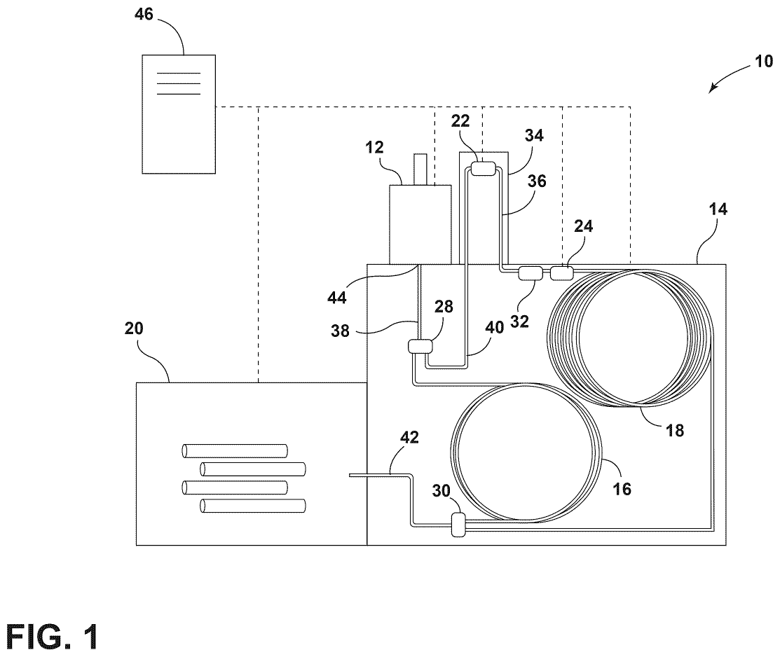

Referring now to FIG. 1, a system for performing EGA-MS and GC-MS is illustrated and generally designated 10. The system 10 includes a micro-furnace 12, an oven 14, an EGA tube 16 within the oven 14, a GC column 18 within the oven 14, and a mass spectrometer 20. The system 10 also includes an external cold trap 22 and an internal cold trap 24 for sequencing evolved gases through the GC column 18 only after the EGA-MS analysis is completed.

More specifically, the micro-furnace 12 is configured to receive and pyrolyze a material sample under precisely controlled heating conditions. The micro-furnace 12 is capable of achieving rapid and reproducible temperature ramps, optionally from ambient temperatures to 700° C. or higher, enabling thermal degradation or pyrolysis of the material sample to generate volatile decomposition products (i.e., evolved gases). Due to its small internal volume and uniform heating profile, the micro-furnace 12 minimizes thermal gradients to ensure the efficient transfer of evolved gases to the EGA tube 16 and the GC column 18.

The oven 14 functions as a thermally controlled enclosure that houses the EGA tube 16 and the GC column 18, as well as associated transfer lines (discussed below). During the EGA-MS mode of operation, the oven sustains a uniform high-temperature environment to facilitate continuous gas transfer from the micro-furnace 12 to the mass spectrometer 20 without condensation or loss of evolved species. Following the EGA analysis, the oven temperature parameters are automatically adjusted for the GC-MS mode of operation, thereby providing precise heating and cooling profiles required for chromatographic separation of the trapped gases.

The EGA tube 16 comprises an inert capillary conduit in fluid communication with the micro-furnace 12 and the mass spectrometer 20. The EGA tube 16 transfers evolved gases directly to the mass spectrometer 20 during the EGA-MS mode of operation, without chromatographic separation. The EGA tube 16 is optionally constructed from stainless steel or fused silica. The EGA tube 16 operates in parallel with the GC column 18, both being connected to an upstream splitter 28 and a downstream splitter 30 within the oven 14. This configuration allows a first portion of the evolved gases to flow directly through the EGA tube 16 for immediate analysis by the mass spectrometer 20, while a second portion of the evolved gases is diverted to the external cold trap 22 for subsequent GC-MS analysis by the mass spectrometer 20.

The GC column 18 comprises a capillary separation device that is fluidly connected between the internal cold trap 24 and the downstream splitter 30, leading to the mass spectrometer 20. The GC column 18 is configured to separate the volatile compounds from the material sample based on their molecular weight, polarity, and volatility, thereby enabling compound-specific mass identification during GC-MS analysis. In one embodiment, the GC column 18 comprises a fused silica or metal capillary having an internal surface coated within a stationary phase such as 5% diphenyl/95% dimethylpolysiloxane. Following completion of the EGA analysis, volatile species (previously condensed in the external cold trap 22) are released and transferred through an internal cold trap 24 via a junction 32 before being introduced at the inlet end of the GC column 32. As the oven temperature follows a controlled GC ramp profile, the compounds are separated along the stationary phase and sequentially elute from the GC column 18 to the mass spectrometer 20. Each compound produces a distinct retention time and corresponding spectrum, permitting unambiguous identification during the GC-MS mode of operation.

As noted above, the system 10 includes an external cold trap 22 and an internal cold trap 24. The cold traps 22, 24 optionally comprise the MicroJet Cryo-Trap MJT-2030E from Frontier Laboratories. The external cold trap 22 services as a temporary storage device during the EGA-MS mode of operation. The external cold trap 22 is fluidly coupled to the oven 14 and is configured to be cooled to cryogenic temperatures, optionally with liquid nitrogen. Upon completion of the EGA-MS mode of operation, the external cold trap is warmed in a controlled manner, such as by a further oven, resistive heating, or directed hot-air flow, to release retained gases into the GC tube 18. In certain embodiments, the external trap 22 is enclosed within an auxiliary oven or thermal housing 34 having independently controlled thermal zones.

The internal cold trap 24 is positioned at the head of the GC column 18. During the GC-MS mode of operation, the internal cold trap 24 is activated to capture and concentrate the gases released from the external cold trap 22. This ensures that the evolved gases are retained at the column inlet until the GC oven temperature program begins. Once the GC analysis is initiated, the internal cold trap 24 is rapidly heated to desorb the retained analytes into the GC column in a narrow, well-defined band, enabling optimal chromatographic resolution.

As also shown in FIG. 1, the system includes a mass spectrometer 20, which is also referred to as a mass selective detector (MSD). The mass spectrometer 20 functions as the analytical detector for both the EGA-MS mode of operation and the GC-MS mode of operation. The mass spectrometer 20 is configured to receive evolved gases from either of the EGA tube 18 or the GC column 16 and measure their mass-to-charge ratios (m/z) through ionization and mass filtering processes. In the EGA-MS mode of operation, the evolved gases are introduced into the mass spectrometer 20 without prior chromatographic separation. The mass spectrometer 20 continuously monitors and records the ion intensity of the evolved gases as a function of temperature, producing a thermogram that reflects the thermal decomposition profile of the sample. This mode of operation allows real-time detection of transient species and direct correlation between gas evolution events and temperature-dependent material transformations.

In the GC-MS mode of operation, the mass spectrometer 20 operates as a detector downstream of the GC column 18. After chromatographic separation of the trapped gases, each component from the column enters the mass spectrometer 20, where it is ionized. The resulting fragment ions are then analyzed by their mass-to-charge ratios. The mass spectrometer generates a mass spectrum for each separated compound, enabling chemical identification based on molecular fragmentation patterns and library matching.

As noted above, the system 10 includes two splitter assemblies: an upstream splitter 28 and a downstream splitter 30. The system 10 also includes four inert transfer lines: a first transfer line 36, a second transfer line 38, a third transfer line 40, and a fourth transfer line 42. Each transfer line is formed from an inert material, such as deactivated stainless steel or fused silica. The upstream splitter 28 is disposed proximal to the oven inlet 44 and is configured to receive the total gas stream (the evolved gases) emerging from the micro-furnace 12 via the second transfer line 38. The upstream splitter 28 includes a single inlet port and two outlet ports: a first outlet port and a second outlet port. The first outlet port directs a first portion of the evolved gases to the external cold trap through the third transfer line 40. The second outlet port directs a second portion of the evolved gases to the EGA tube 16 for immediate EGA-MS analysis.

The flow ratio between the first and second outlet ports can be controlled by the dimensions of their respective lines or by the carrier gas pressure settings. The downstream splitter 30 is positioned downstream of both the EGA tube 16 and the GC column 18 and is configured to recombine the separated gas streams prior to introduction into the mass spectrometer 20. The downstream splitter 30 includes two inlet ports and one outlet port, thereby merging the effluents from the EGA tube 16 and the GC column 18 into a unified stream that exits the oven 14 via the fourth transfer line 42. The outlet of the downstream splitter 30 is fluidly coupled to the mass spectrometer 20, optionally via a vent-free GC-MS adaptor. This configuration ensures that, regardless of the mode of operation, all gaseous products are directed toward the same mass spectrometer 20 without requiring manual reconnection or realignment of hardware.

Lastly, the system 10 includes a control module 46. The control module 46 includes a processor with machine readable instructions that, when executed, control operation of the system 10. The control module 46 governs the coordinated operation of the micro-furnace 12, the oven 14, the external and internal cold traps 22, 24, the mass spectrometer 20, and the external oven(s) 34, 52. During the EGA-MS mode of operation, the control module 46 executes a temperature program that ramps the micro-furnace 12 and that maintains the oven 14 in a high-temperature, isothermal condition that is suitable for evolved gas transfer. The control module 46 simultaneously activates the external cold trap 22 to cryogenically condense the fraction of gases diverted from the upstream splitter 28, while recording ion intensity data from the mass spectrometer to produce the EGA thermogram. Upon completion of the EGA analysis, the control module 46 transitions to the GC-MS mode of operation by initiating a programmed oven cooling sequency, deactivating the external cold trap 22, and activating the internal cold trap 24 to capture gases as they are released. The control module 46 then triggers a controlled heating cycle for the external cold trap 22 to release the retained gases and synchronize their transfer into the GC column 18. Once the gases are trapped internally, the control module 46 initiates the GC oven temperature ramp and switches the mass spectrometer 20 to a chromatographic mode for generating time-resolved GC-MS chromatograms. In some embodiments, the control module 46 includes a user interface that is configured to display thermal, chromatographic, and spectral data for polymer identification or kinetic modeling.

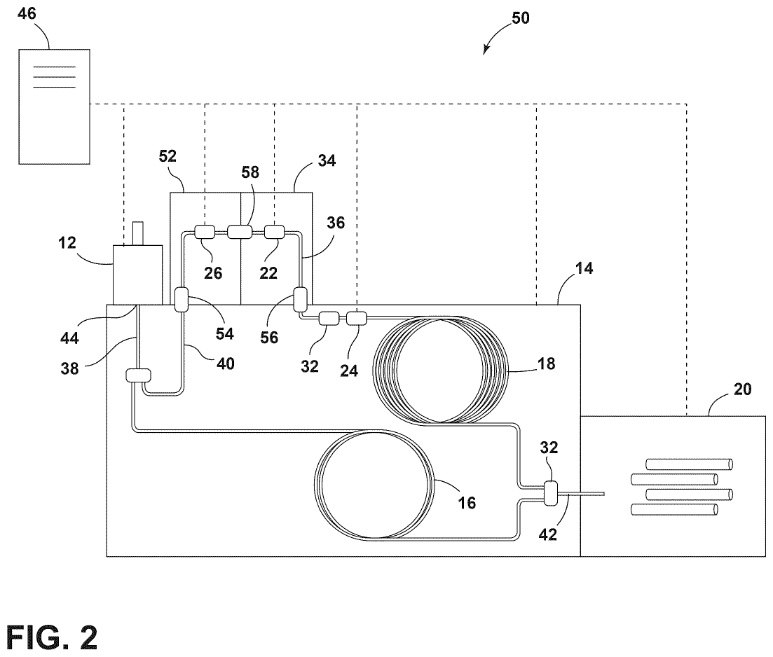

A further embodiment is illustrated in FIG. 2 and generally designated 50. This embodiment is similar in structure and in function to the embodiment of FIG. 1, except that a further external oven and cold trap are provided for sequestering a third portion of the evolved gases from the micro-furnace. In particular, the system 50 includes a further exterior oven 52, such that the system 50 includes split thermal zones for two external cold traps: a first external cold trap 22 and a second external cold trap 26. This embodiment also includes first and second heated transfer lines 54, 56 between the primary oven 14 and the exterior ovens 34, 52, and a third heated transfer line 58 between the two exterior ovens 34, 52. This configuration allows for the real-time separation of thermal desorption and pyrolysis products. The first external cold trap 22 captures evolved products produced during the thermal desorption zone of the sample, observed by monitoring the real time EGA thermogram. Once thermal desorption is completed, the second external cold trap 26 is turned on and captures products produced from pyrolysis of the sample. Still other embodiments can have three or more external cold traps as desired.

### II. Method of Operation

The corresponding method of operation include the following steps: (a) heating the sample within the micro-furnace to generate evolved gases; (b) diverting a first portion of the evolved gases to the external cold trap to condense and retain the gases therein while directing a second portion of the evolved gases through the EGA tube to a mass spectrometer to perform an EGA-MS analysis on the sample; (c) after performing the EGA-MS analysis, turning on the internal cold trap and then heating the external cold trap to release the evolved gases contained therein and diverting the evolved gases to the GC column; and (d) performing a GC-MS analysis on evolved gases flowing through the GC column to obtain chromatographically separated mass spectral data of the sample. Each such step is discussed below.

At step (a), the sample (e.g., a polymeric or organic material in microgram quantities) is introduced into the micro-furnace and subjected to a programmed heating sequence. As the sample temperature increases, it undergoes thermal decomposition or pyrolysis, producing evolved gases that are carried from the micro-furnace by an inert gas, such as helium, into the oven. At step (b), the total evolved gas stream is divided by the upstream splitter into two separate portions. A first portion of the evolved gases is diverted through a dedicated transfer line to the external cold trap. The external cold trap is maintained at cryogenic temperatures to condense and retain a representative sample of the same gases for subsequent chromatographic analysis. Simultaneously, a second portion of the evolved gases is directed through the EGA tube to the mass spectrometer for an EGA-MS analysis.

At step (c), upon completion of the EGA analysis, the control module transitions the system to a GC-MS mode of operation. The oven temperature is adjusted to a lower set point that is suitable for gas chromatographic separation, while the internal cold trap, located at the inlet of the GC column, is activated. The external cold trap is gradually warmed to release the previously condensed gases. The released gas flows through the internal cold trap, where they are recondensed and concentrated at the column head until the GC temperature program is initiated. In embodiments having a second external cold trap the first external cold trap captures evolved products produced during the thermal desorption zone of the sample, observed by monitoring the real time EGA thermogram. Once thermal desorption is completed, the second external cold trap is turned on and captures products produced from pyrolysis of the sample.

At step (d), the control module deactivates the internal cold trap and initiates an oven temperature ramp for the GC-MS analysis. The trapped gases are desorbed into the GC column and undergo chromatographic separation according to their volatility and interaction with the stationary phase. As each component elutes from the GC column, it passes through the downstream splitter and enters the mass spectrometer. The mass spectrometer records the corresponding mass spectra and chromatographic retention times. The resulting dataset provides a detailed chemical identification and quantitation of the sample's decomposition products.

By integrating evolved gas analysis and gas chromatographic separation within a single continuous analytical sequence, the present invention eliminates the need for multiple sample runs, extensive hardware reconfiguration, and duplicate data acquisition procedures. The present invention performs both analyses on the same sample, thereby ensuring a direct and quantifiable correlation between the thermal evolution profile (from the EGA analysis) and the chemical identities of its decomposition products (from the GC analysis). This correlation is particularly valuable for heterogeneous or limited quantity materials, such as forensic samples, specialty polymers, or conservation artifacts. The dual cold trap configuration, including both external and internal traps, enables efficient capture, storage, and timed release of evolved gases while preventing condensation losses. Lastly, the splitter assemblies provide stable and reproducible division and recombination of gas streams, allowing simultaneous EGA monitoring and deferred GC separation without manual intervention.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims.

1. A system for enabling tandem pyrolysis/evolved gas—gas chromatography—mass spectroscopy (Py/EG-GC-MS) in conjunction with an oven having an inlet coupled with a micro-furnace and an outlet coupled with a mass spectrometer, the system comprising:
an evolved gas analysis (EGA) tube disposed inside the oven and having an input end and an output end;
a gas chromatography (GC) column disposed inside the oven and having an input end and an output end;
an internal cold trap disposed inside the oven adjacent to the input end off the GC column;
first, second, third, and fourth transfer lines;
an external cold trap disposed outside of the oven and in fluid communication with the internal cold trap through the first transfer line;
an upstream splitter disposed inside the oven and having an input connected to the oven inlet via the second transfer line, a first output port connected to the external cold trap through the third transfer line, and a second output port connected to the input end of the EGA tube;
a downstream splitter disposed inside the oven and having a first input port connected to the output end of the GC column, a second input port connected to the output end of the EGA tube, and an output port connected to the oven outlet via the fourth transfer line; and
a control module configured to:
cause the external cold trap to retain a first portion of a sample to prevent it from reaching the internal cold trap while the system performs, over a first time interval, a EGA on a remaining, second portion of the sample that is guided through the EGA tube;
cause the external cold trap to release the first portion of the sample to allow it to reach the internal cold trap over a second time interval succeeding the first time interval, and cause the internal cold trap to retain the first portion of the sample to prevent it from reaching the GC column; and
cause the internal cold trap to release the first portion of the sample to allow the system to perform, over a third time interval succeeding the second time interval, a CG analysis on the first portion that is guided through the GC column.

2. The system of claim 1, further comprising an external oven that encapsulates the external cold trap.

3. The system of claim 2, further comprising:
a second external cold trap disposed between the upstream splitter's first output port and the first external cold trap, and a second external oven that encapsulates the second external cold trap, wherein the control module is configured to cause: activation of the first external cold trap, followed by activation of the second external cold trap, followed by deactivation of the first external cold trap, followed by deactivation of the second external cold trap.

4. The system of claim 1, wherein the sample is a polymer that is disposed in the micro-furnace.

5. The system of claim 1, wherein the external cold trap is cooled using liquid nitrogen to maintain internal temperatures to below-100° C.

6. The system of claim 1, wherein the control module is further configured to activate and deactivate the external cold trap and the internal cold trap based on temperature feedback from the oven and the external cold trap.

7. The system of claim 1, wherein the mass spectrometer comprises a quadrupole mass selective detector (MSD) configured to detect evolved gases based on their mass-to-charge ratio.

8. The system of claim 1, wherein the external cold trap is reheated by a controlled heating element or a directed hot-air source to transfer the retained gases into the GC column.

9. The system of claim 1, wherein the first, second, third, and fourth transfer lines each comprise an inert conduit formed from deactivated stainless steel or fused silica.

10. The system of claim 1, wherein the GC column comprises fused silica or metal capillary having an internal surface that is coated within a stationary phase.

11. A method for performing tandem pyrolysis/evolved gas—gas chromatography—mass spectroscopy (Py/EG-GC-MS) on a sample, the method comprising:
introducing a sample into a micro-furnace, the micro-furnace being in fluid communication with an oven;
heating the sample within the micro-furnace to generate evolved gases, the evolved gases being permitted to flow into the oven;
diverting a first portion of the evolved gases to a first external cold trap, the first external cold trap being outside of the oven, and cooling the first external cold trap to condense and retain the first portion of the evolved gases therein;
directing a second portion of the evolved gases through an evolved gas analysis (EGA) tube to a mass spectrometer to obtain a thermal profile of the sample, the EGA tube being contained within the oven;
conducting an evolved gas analysis of the second portion of the evolved gases at the mass spectrometer;
after conducting the evolved gas analysis, heating the first external cold trap to release the first portion of the evolved gases into a gas chromatography (GC) column;
performing a gas chromatography mass spectrometry analysis on the first portion of the evolved gases to obtain mass spectral data of the sample.

12. The method of claim 11, further including monitoring a temperature of the internal cold and the first external cold trap for controlling activation of the internal cold trap and the external cold trap.

13. The method of claim 11, further comprising reheating the first external cold trap using a controlled heating element or a directed hot-air source.

14. The method of claim 11, further comprising activating and deactivating the first external cold trap and the internal cold trap based on temperature feedback from the oven and the external cold trap.

15. The method of claim 11, wherein the first external cold trap is contained within an external oven.

16. The method of claim 11, further comprising diverting a third portion of the evolved gases to a second external cold trap, the second external cold trap being outside of the oven, and cooling the second external cold trap to condense and retain the third portion of the evolved gases therein.

17. The method of claim 16, further comprising performing a gas chromatography mass spectrometry analysis on the third portion of the evolved gases after performing a gas chromatography mass spectrometry analysis on the first portion of the evolved gases.

18. The method of claim 11, wherein the GC column comprises fused silica or metal capillary having an internal surface that is coated within a stationary phase.

19. The method of claim 11, wherein the EGA tube comprises an inert conduit formed from deactivated stainless steel or fused silica.

20. The method of claim 11, wherein the mass spectrometer comprises a quadrupole mass selective detector (MSD) configured to detect evolved gases based on their mass-to-charge ratio.
